(19) United States
(12) Patent Application Publication
(10) Pub. No.: US 2008/0171310 A1
(43) Pub. Date: Jul. 17, 2008

(54) Swim lap counter

(76) Inventor: Eloise M. Wiles, Columbus, OH (US)

Correspondence Address: MUELLER AND SMITH, LPA;MUELLER-SMITH BUILDING, 7700 RIVERS EDGE DRIVE, COLUMBUS, OH, 43235, US

(21) Appl. No.: 11/654,287

(22) Filed: Jan. 17, 2007

(51) Int. Cl. G06C 1/00

(52) U.S. Cl. 434/203

(57) ABSTRACT

A method for a swimmer swimming laps in a swimming pool to record the number of laps swum employs a swim lap counter having a pair of floatable end blocks and a series of parallel rods extending between the floatable end blocks. Each rod carries a series of apertured beads movable from being adjacent to one of the floatable end blocks to being adjacent to the other floatable end block. Each bead and each row of beads represents laps swum by the swimmer. The swim lap counter is placed at one end of the swimming pool. The swimmer moves the beads from being adjacent to one of the floatable end blocks to being adjacent to the other floatable end block to record the number of laps swum by the swimmer.

### CROSS-REFERENCE TO RELATED APPLICATIONS

None

### STATEMENT REGARDING FEDERALLY SPONSORED RESEARCH

Not applicable.

### BACKGROUND OF THE INVENTION

The present invention generally relates to counting devices and more particularly to a device for a swimmer to facilely record the number of laps completed.

Swimming not only is a competitive sport requiring participants to swim laps as part of a training regimen, but also is an excellent, non-weight bearing, cardiovascular exercise regimen practiced by people for losing weight, maintaining weight, exercising their heart (for example, after a heart attack or other heart episode), or the like.

Regardless of the motivation for swimming laps, the swimmer often wants and/or needs to know how many laps they have swum. Since the swimmer is in a swimming pool, it is difficult for the swimmer to actuate a counting device. True, that electronic counters using a touch pad at one of the pool or other expensive electronic devices can be used, but the ordinary, local swimming pool ordinarily cannot justify the cost of such devices.

The art has proposed bead arrangements like an abacus for use in sports, games, and education. Typical of the sports counters is Japanese publication number 09313661 which shows a golf glove bead counter mounted on the back of the hand portion of the golf glove; U.S. Pat. No. 4,021,039 which shows a miniature tennis game with bead counter; U.S. Pat. No. 2,527,621 which shows a bead counter for shuffleboard; U.S. Pat. No. 4,029,3113 which proposes a pool table canopy with bead counter; and U.S. Pat. No. 6,511,066 which shows a dart game bead counter. In the education area are U.S. Pat. Nos. 2,646,631, 2,645,440, 5,205,747, and 5,395,245. In the game area are U.S. Pat. Nos. 3,144,252, 4,327,910, 4,410,182, 6,315,675, and Des. 417,405. None of these devices is adapted for use as a swim lap counter activatable by the swimmer swimming the laps.

There is a need, then, for a simple, inexpensive lap counter for a swimming to actuate in order to count the number of laps swum by the swimmer. It is to such a device that the present invention is addressed.

### BRIEF SUMMARY OF THE INVENTION

A method disclosed for a swimmer swimming laps in a swimming pool to record the number of laps swum employs a swim lap counter having a pair of floatable end blocks and a series of parallel rods extending between the floatable end blocks. Each rod carries a series of apertured beads movable from being adjacent to one of the floatable end blocks to being adjacent to the other floatable end block. Each bead and each row of beads represents laps swum by the swimmer. The swim lap counter is placed at one end of the swimming pool. The swimmer moves the beads from being adjacent to one of the floatable end blocks to being adjacent to the other floatable end block to record the number of laps swum by the swimmer.

The swim lap counter disclosed has a pair of floatable end blocks and a series of parallel rods extending between the floatable end blocks. Each rod carries a series of apertured beads movable from being adjacent to one of the floatable end blocks to being adjacent to the other floatable end block. Each bead and each row of beads represents laps swum by the swimmer. The swim lap counter is placed at one end of the swimming pool. The swimmer moves the beads from being adjacent to one of the floatable end blocks to being adjacent to the other floatable end block to record the number of laps swum by the swimmer.

Advantages of the present invention include a swim lap counter that is inexpensive and easy to use. Another advantage is a swim lap counter usable by the swimmer to record the number of laps swum. A further advantage is a swim lap counter that can be placed on the pool end or in the water for use by the swimmer. These and other advantages will be readily apparent to the skilled artisan based on the disclosure set forth herein.

### BRIEF DESCRIPTION OF THE DRAWINGS

For a fuller understanding of the nature and advantages of the present invention, reference should be had to the following detailed description taken in connection with the accompanying drawings, in which:

FIG. 1 is a perspective view of the disclosed swim lap counter having two rows of movable beads;

FIG. 2 is a side elevational view of the swim lap counter of FIG. 1;

FIG. 3 is a perspective view of another embodiment of the disclosed swim lap counter having four rows of movable beads;

FIG. 4 is a side elevational view of the swim lap counter of FIG. 3; and

FIG. 5 is a partial perspective view of the swim lap counter of FIGS. 1 and 2, one disposed in the water adjacent to one end of the swimming pool and the other being disposed on the edge of the swimming pool.

The drawings will be described in greater detail in the disclosure set forth below.

### DETAILED DESCRIPTION OF THE INVENTION

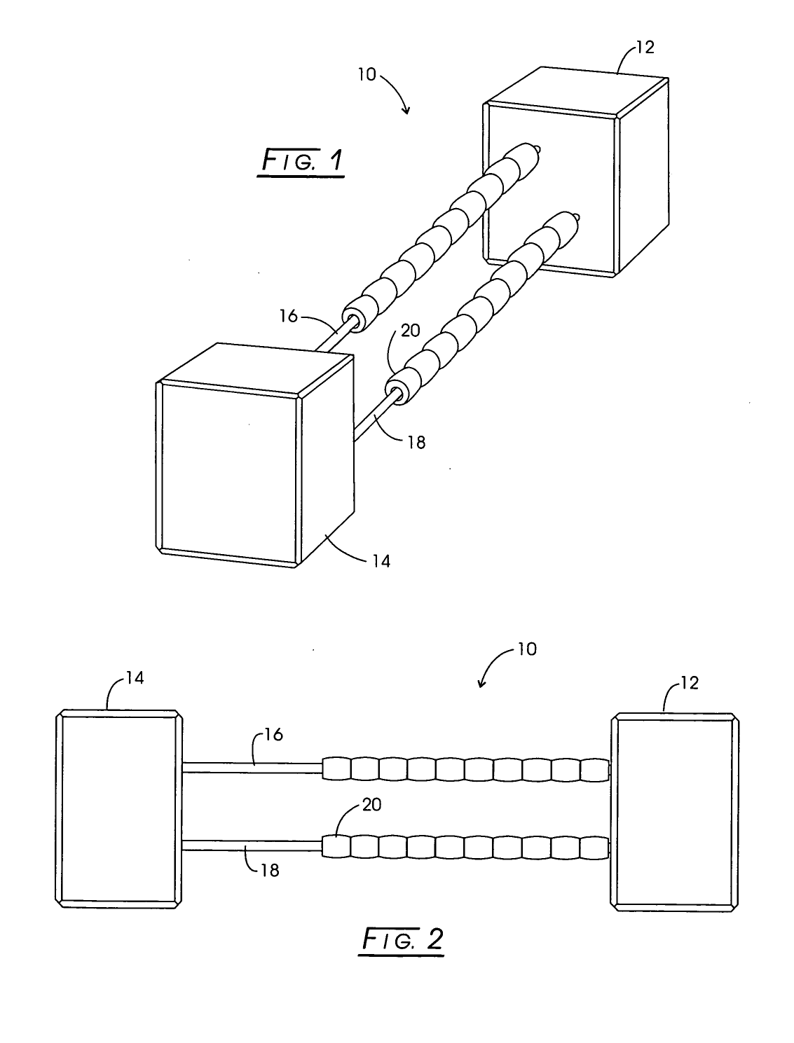

Referring initially to FIGS. 1 and 2, a swim lap counter, 10, includes a pair of floatable end blocks, 12 and 14; a pair of elongate rods, 16 and 18; and a series of apertured beads, a representative bead, 20, being described as illustrate of all of said beads herein. Each end block 12 and 14 are made from material that permits swim lap counter 10 to float on water in a swimming pool. As a practical matter, a polymeric material can be used for forming end blocks 12 and 14, such as, for example, polyurethane, vinyl polymers, rubbers, and the like. Such material can be manufactured to incorporate air to decrease the density (e.g., create a foam); contain a pouch for filing with air or other gas; or the like; or combinations. Regardless of how accomplished, end blocks 12 and 14 have a density such that they float and support the entire weight of swim lap counter 10 atop the water in a swimming pool.

Elongate rods 16 and 18 extend between end blocks 12 and 14. The ends of elongate rods 16 and 18 can simply be pressure inserted into the material forming end blocks 12 and 14; holes can be drilled or otherwise formed in the material forming end blocks 12 and 14 to receive the ends of elongate rods 16 and 18; or the like. Adhesive optionally can be used to retain elongate rods 16 and 18, especially in the aqueous environment in which they will be disposed and exposed to. In fact, elongate rods 16 and 18 can extend through the entire extent of the material forming end blocks 12 and 14 and secured via, for example, a nut if the ends of elongate rods 16 and 18 are threaded. Other means to fix the ends of elongate rods 16 and 18 for prevent them from dislodging from their engagement by end blocks 12 and 14 can be envisioned and are applicable to the disclosure set forth herein.

Elongate rods 16 and 18 desirably are made from material resistant to damage from the aqueous environment in which swim lap counter 10 will be used. Appropriate materials include, for example, plastic, corrosion-resistant metal, metal having a corrosion-resistant coating or treatment, or the like. Elongate rods 16 and 18 desirably also are disposed diagonally opposite each other with respect to end blocks 12 and 14, as illustrated. Such arrangement makes it easier for the swimmer to move the beads without an unintended movement of the beads on the other rod.

As stated above, bead 20 will be described as illustrative of all of the apertured beads carried by elongate rods 16 and 18. Bead 20 also will be made from plastic or other material resistant to damage (e.g., corrosion) caused by the aqueous swimming pool environment. Plastic beads, then, will be used for cost and their water resistance. Bead 20 is apertured so that rod 18 can fit therethrough and permit bead 20 to be moved along the lengthwise extend of rod 18 from end block 12 to end block 14, and vice versa. Desirably, bead 20 will fit a bit snugly onto rod 18 so that bead 20 will not move along the lengthwise extent of rod 18 due to the rocking motion of the water or other adventitious sources. That is, bead 20 should not move unless moved by the swimmer or other person activating swim lap counter 10 in counting the number of laps swum by the swimmer.

The beads carried by rod 16 can be different in color than the beads carried by rod 18, as can the beads carried by each rod. Color coding can alert the swimmer as to which rod should be the current active rod to record the number of laps swum by movement of beads along such rod from one side to the other side, i.e., from being in (contacting) adjacency of one end block to (contacting) adjacency of the other end block. In fact, the beads on each rod can be color coded also, as is necessary, desirable, or convenient. Each row of beads also can represent a single lap, 5 laps, 10 laps, or any other number of laps. In that way, sequences of beads along each rod can count a very high number of laps swum.

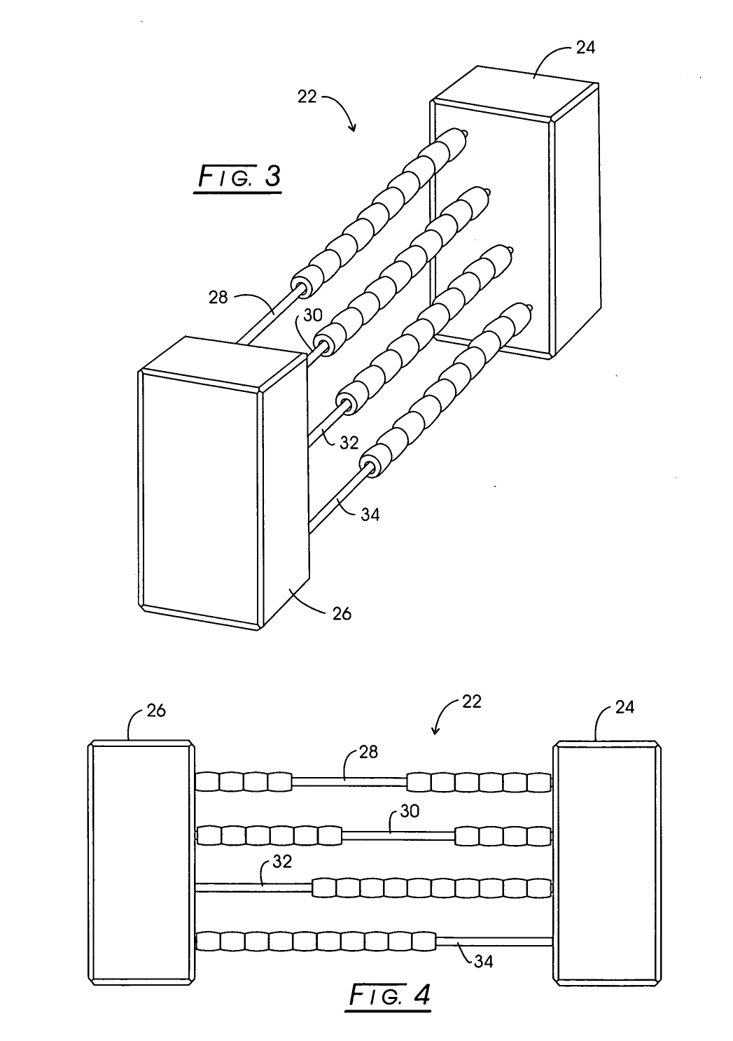

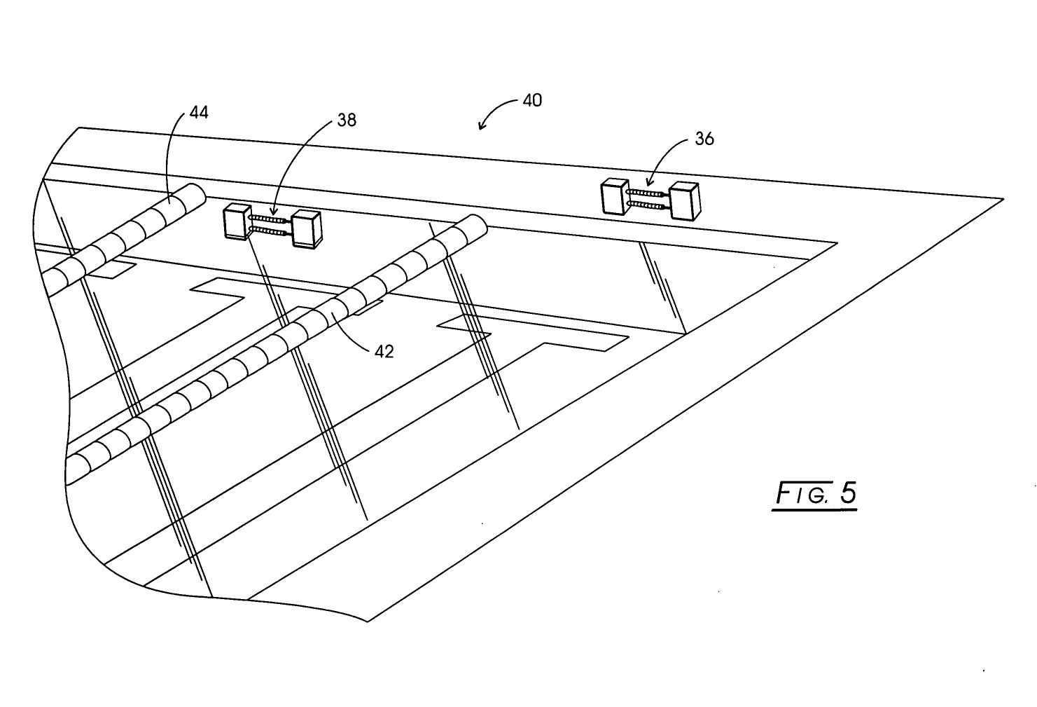

Referring now to FIGS. 3 and 4, a swim lap counter, 22, is seen to include a pair of end blocks, 24 and 26; four elongate rods, 28, 30, 32, and 34; and 10 beads carried by each rod. The number of beads shown in FIGS. 3 and 4 are illustrative only as any number of beads can be used. For example, the row of beads carried by rod 28 can represent a single lap; the beads carried by rod 30 can represent 5 laps; the beads carried by rod 32 can represent 10 laps; and the beads carried by rod 34 can represent 20 laps. Again, the number of laps represented by each row of beads is illustrative, as the swimmer can let each bead and each row of beads stand for any number of laps. So too can the number of rods be different in number than the 2 rod and 4 rod embodiments illustrated in the drawings.

Again, rods 28, 30, 32, and 34 are arranged diagonally from one corner of each end block 24 and 26 to assist the swimmer in moving the beads only on a desired rod. Such lateral stagger of the rods also is present in swim lap counter 10, as described above. While the rods need not be so staggered, it is desirable so as to enable the swimmer to locate and identify the desired rod and move only the beads along that desired rod. Color-coding of the beads along each row also is a visual cuing system enabling the swimmer to locate and identify the desired row for movement of the beads.

Referring now to FIG. 5, a swim lap counter, 36, is shown placed on the edge of a pool, 40, and a swim lap counter, 38, is shown in the water filling pool 40. Pool 40 is a typical swimming pool having lane dividers, 42 and 44, which separate the pool into lanes for swimmers to swim laps. An advantage of the use of the disclosed floatable swim lap counters is their ability to be used by the swimmer and the ability to be used along side one end of the pool and in the water, as illustrated in FIG. 5. Each time the swimmer reaches either swim lap counter 36 or swim lap counter 38, the swimmer need only move a bead on one of the rods from one side to the other side to record the number of laps swum. Each swim lap counter also can be readily re-set by merely moving the beads to be up against one of the floatable end blocks. It matters not which end blocks is chosen, as the disclosed swim lap counter works in both directions, i.e., is reversibly operable.

As further illustrative of the disclosed swim lap counter, each floatable end block can have nominal dimensions of about 8″×6″×4″. A pair of 14″ rods spans between these end blocks diagonally opposite each other. Each rod carries ten round apertured beads. One row of beads is black and the other row of beads is red. Again, such a lap counter is merely illustrate and not limitative.

While the invention has been described with reference to various embodiments, those skilled in the art will understand that various changes may be made and equivalents may be substituted for elements thereof without departing from the scope and essence of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. In this application all units are in the American system and all amounts and percentages are by weight, unless otherwise expressly indicated. Also, all citations referred herein are expressly incorporated herein by reference.

1. A method for a swimmer swimming laps in a swimming pool to record the number of laps swum, said swimming pool having a pair of ends between which said swimmer swims laps, which comprises the steps of:
(I) providing a swim lap counter, which comprises:
(a) a pair of floatable end blocks;
(b) a series of parallel rods extending between said floatable end blocks; and
(c) each rod carrying a series of apertured beads movable from being adjacent to one of said floatable end blocks to being adjacent to said other floatable end block, each bead and each row of beads representing laps swum by said swimmer;
(II) disposing said swim lap counter at one end of said swimming pool; and
(III) said swimmer moving said beads from being adjacent to one of said floatable end blocks to being adjacent to said other said floatable end block to record the number of laps swum by said swimmer.

2. The method of claim 1, wherein said rods are disposed diagonally across each end block.

3. The method of claim 1, wherein each row of beads is different in color.

4. The method of claim 1, wherein said swim lap counter is disposed in the swimming pool.

5. The method of claim 1, wherein said swim lap counter is disposed outside of the swimming pool.

6. The method of claim 1, wherein said swim lap counter is made from materials resistant to corrosion.

7. The method of claim 2, wherein each row of beads is different in color.

8-12. (canceled)
